(19) United States
(12) Patent Application Publication
(10) Pub. No.: US 2012/0106184 A1
(43) Pub. Date: May 3, 2012

(54) ILLUMINATION APPARATUS AND VEHICULAR HEADLAMP

(75) Inventors: Katsuhiko KISHIMOTO, Osaka-shi (JP); Kohsei TAKAHASHI, Osaka-shi (JP)

(73) Assignee: SHARP KABUSHIKI KAISHA, Osaka-shi (JP)

(21) Appl. No.: 13/281,157

(22) Filed: Oct. 25, 2011

(30) Foreign Application Priority Data
Oct. 29, 2010 (JP) 2010-244571

(51) Int. Cl. B60Q 1/04; F21V 9/16

(52) U.S. Cl. 362/510; 362/84

(57) ABSTRACT

A headlamp includes a semiconductor laser for emitting laser beams having a bluish purple oscillation wavelength, a light emitting section for emitting light while being irradiated with the laser beams emitted from the semiconductor laser, and a transmission filter for shielding coherent components included in the laser beams whereas transmitting incoherent components included in the laser beams.

This Nonprovisional application claims priority under 35 U.S.C. §119(a) on Patent Application No. 2010-244571 filed in Japan on Oct. 29, 2010, the entire contents of which are hereby incorporated by reference.

### TECHNICAL FIELD

The present invention relates to an illumination apparatus, particularly to a vehicular headlamp, which includes an excitation light source and a light emitting section that emits fluorescence while being irradiated with exciting light emitted from the excitation light source.

### BACKGROUND ART

A vehicular headlamp, which employs a white LED (Light Emitting Diode) in which a blue light emitting diode and a fluorescent material are used in combination, has started to be put to practical use. A light emitting diode has its operating life remarkably longer than that of a halogen lamp or an HID (High Intensity Discharge) lamp that has been a conventional light source. It is considered that the light emitting diode will allow, in the feature, a further reduction in its power consumption as compared with the HID lamp.

Patent Literatures 1 and 2 disclose respective examples of such a headlamp. A vehicular headlamp disclosed in each of Patent Literatures 1 and 2 includes a plurality of LED chips that emit respective different colors. According to a technique of Patent Literature 1, the vehicular headlamp emits (i) white light whose amount has been decreased according to circumstances and (ii) green light, orange light or light of other color. This allows suppression of a deterioration in visibility caused by adverse weather such as rainy weather, dense fog or fallen snow. Meanwhile, according to a technique of Patent Literature 2, the vehicular headlight emits red light and green light that allow a driver to promptly distinguish a pedestrian from an object so that the pedestrian is quickly distinguished.

Humans sense light by visual cells of their retinas. The visual cells include a cone cell and a rod cell whose sensitivity to light are different from each other. A visual sense of eyes in an environment of full of light (in bright light) is called photopic vision. In the photopic vision, the cone cell functions and mainly senses a color shade and/or a shape. Meanwhile, a visual sense of eyes in dark light is called scotopic vision. In the scotopic vision, the rod cell functions and mainly senses contrast of light.

In the photopic vision, the sensitivity becomes highest to light having a yellowish green wavelength of 555 nm. Meanwhile, in the scotopic vision, the sensitivity becomes highest to light having a slightly bluish wavelength of 507 nm. That is, a peak wavelength of spectral luminous efficiency in the photopic vision is different from that in the scotopic vision. The peak wavelength of the spectral luminous efficiency in the scotopic vision shifts to a wavelength shorter than that of the spectral luminous efficiency in the photopic vision. Such a phenomenon is called Purkinje phenomenon.

Patent Literature 3 discloses a visual line guidance system in which the Purkinje phenomenon is taken into consideration, and Patent Literature 4 discloses a retroreflector.

The visual line guidance system disclosed in Patent Literature 3 emits light (light having a short wavelength such as a blue wavelength or a green wavelength) whose color is easily visible in dark light while the visual line guidance system is not detecting light emitted from a headlamp. Meanwhile, the visual line guidance system emits light (light having a long wavelength such as a red wavelength or an orange wavelength) whose color is easily visible in bright light while the visual line guidance system is detecting the light emitted from the headlamp. This allows a high visibility to both a vehicle that emits light via its headlamp and a vehicle that do not emit light via its headlamp.

A base material and a colored transparent layer of the retroreflector disclosed in Patent Literature 4 are a blue one and a yellowish green one, respectively. The retroreflector shows yellowish green whose photopic relative luminosity is high in bright light such as in the daytime or in the twilight. Meanwhile, the retroreflector shows blue (wavelength of approximately 507 nm) whose scotopic relative luminosity is high in the dark of nighttime by reflecting light emitted from a headlamp. This allows the retroreflector to favorably carry out visual guidance regardless of day and night.

### CITATION LIST

### Patent Literature

Patent Literature 1
Japanese patent Application Publication, Tokukai No. 2006-351369 A (Publication Date: Dec. 28, 2006)

Patent Literature 2
Japanese patent Application Publication, Tokukai No. 2009-286198 A (Publication Date: Dec. 10, 2009)

Patent Literature 3
Japanese patent Application Publication, Tokukai No. 2009-235860 A (Publication Date: Oct. 15, 2009)

Patent Literature 4
Japanese patent Application Publication, Tokukai No. 2004-301977 A (Publication Date: Oct. 28, 2004)

### SUMMARY OF INVENTION

### Technical Problem

A vehicular headlamp and a visual line guidance system disclosed in Patent Literatures 1 through 3 include a light emitting diode as a light source, emit outside part of light emitted from the light emitting diode as it is, and employ the part of light as illumination light. This is based on the fact that, since the light emitting diode does not emit coherent light though, for example, a laser light source emits coherent light, the human eyes are unlikely to be damaged by the light emitted from the light emitting diode even in a case where human eyes directly see the light emitted from the light emitting diode. In contrast, laser beams emitted from the laser light source contain coherent components as main components. Therefore, human eyes are likely to be damaged by the laser beams in a case where the laser beams are emitted outside as they are from the laser light source.

An illumination apparatus, including a laser light source, which emits illumination light having a high color temperature has been eagerly required. Usage of a blue fluorescent material makes it possible to theoretically increase the color temperature of illumination light. However, the blue fluorescent material, which has a high emission efficiency and is suitable for an illumination apparatus including a semiconductor laser, has been hard to find. As such, it has been difficult to increase the color temperature of illumination light by use of the blue fluorescent material. It has also been difficult to increase the color temperature of illumination light (white light), by shielding the laser beams emitted from the laser light source in consideration of safety and by using the blue fluorescent material for a light emitting section.

Each technique of Patent Literatures 1 through 3 employs a light emitting diode as a light source. Therefore, none of the techniques of Patent Literatures 1 through 3, of course, considers that laser beams emitted from a laser light source are used as part of illumination light so that a color temperature is increased. The retroreflector disclosed in Patent Literature 4 does not include any light source but merely reflects irradiation light. Therefore, the technique of Patent Literature 4, of course, does not consider at all the increasing of the color temperature, either.

The present invention was made in view of the problem, and an object of the present invention is to provide an illumination apparatus and a vehicular headlamp that are capable of increasing a color temperature of illumination light to be emitted outside.

### Solution to Problem

In order to attain the object, an illumination apparatus of the present invention includes an excitation light source for emitting exciting light having a bluish purple oscillation wavelength; a light emitting section for emitting light while being irradiated with the exciting light emitted from the excitation light source; and a transmission filter for shielding coherent components included in the exciting light whereas transmitting incoherent components included in the exciting light.

According to the configuration, the excitation light source emits the exciting light having the bluish purple oscillation wavelength, and the transmission filter transmits the incoherent components included in the exciting light. This allows the illumination apparatus to emit not only the light emitted from the light emitting section but also incoherent light that (i) leaks out from the light emitting section (or that is not emitted to the light emitting section), (ii) has a wavelength which falls in the vicinity of the bluish purple wavelength range and (iii) has a high color temperature. It is therefore increase a color temperature of illumination light.

The transmission filter shields the coherent components included in the exciting light, whereas transmits the incoherent components included in the exciting light. Coherent components are likely to damage human eyes. In contrast, incoherent components are less likely to damage human eyes. It is therefore possible to prevent human eyes from being damaged by the illumination light. That is, safety of the human eyes can be secured while the color temperature is increased.

Note, however, that the transmission filter does not necessarily (i) shield all of the coherent components and (ii) transmit all of the incoherent components.

### Advantageous Effects of Invention

As described above, an illumination apparatus of the present invention includes an excitation light source for emitting exciting light having a bluish purple oscillation wavelength; a light emitting section for emitting light while being irradiated with the exciting light emitted from the excitation light source; and a transmission filter for shielding coherent components included in the exciting light whereas transmitting incoherent components included in the exciting light.

This allows the illumination apparatus of the present invention to bring about an effect of increasing a color temperature of illumination light.

### BRIEF DESCRIPTION OF DRAWINGS

FIG. 1 is a view schematically showing a configuration of a headlamp in accordance with an embodiment of the present invention.

FIG. 2(a) is a view showing components of laser beams emitted from a semiconductor laser included in a headlamp in accordance with an embodiment of the present invention, and a graph showing how an emission spectrum of the laser beams emitted from the semiconductor laser is distributed in a wavelength range from 350 nm to 460 nm.

FIG. 2(b) is a view showing the components of the laser beams emitted from the semiconductor laser, and a graph showing how the emission spectrum of the laser beams is distributed in an entire wavelength range of visible light.

FIG. 3 is a graph showing a chromaticity range of white required for a vehicular headlamp.

FIG. 4(a) is a view schematically showing a circuit of a semiconductor laser.

FIG. 4(b) is a perspective view showing a basic configuration of a semiconductor laser.

FIG. 5 is a perspective view showing another example of a basic configuration of a gain guide semiconductor laser.

FIG. 6 is a cross-sectional view schematically showing a configuration of a headlamp in accordance with another embodiment of the present invention.

FIG. 7 is a view showing a positional relationship of an end part of an optical fiber with a light emitting section that are included in a headlamp in accordance with another embodiment of the present invention.

FIG. 8 is a view schematically showing external appearances of (i) a light emitting unit included in a laser down light in accordance with an embodiment of the present invention and (ii) a conventional LED down light.

FIG. 9 is a cross-sectional view of a ceiling on which the laser down light is provided.

FIG. 10 is a cross-sectional view of the laser down light.

FIG. 11 is a cross-sectional view showing a modified example of a method for providing the laser down light.

FIG. 12 is a cross-sectional view of a ceiling on which the LED down light is provided.

FIG. 13 is a table showing a comparison of specifications of the laser down light and the LED down light.

### DESCRIPTION OF EMBODIMENTS

### Embodiment 1

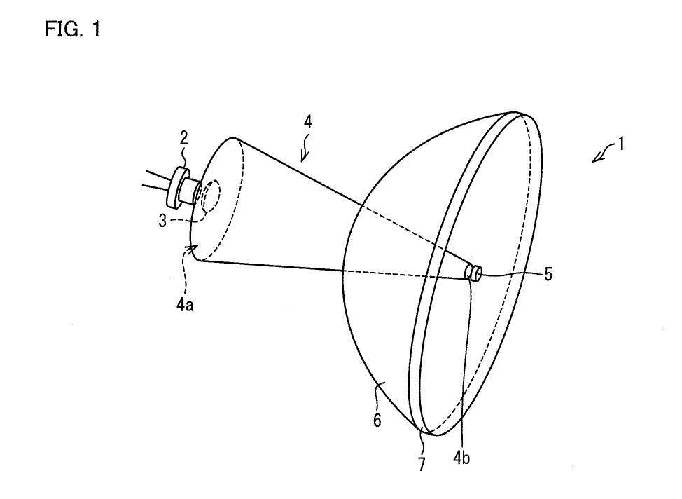

The following describes an embodiment of the present invention with reference to FIGS. 1 through 7.

(Technical Idea of the Present Invention)

Exciting light emitted from an excitation light source contains coherent components and incoherent components. The coherent components are likely to damage human eyes. In contrast, the incoherent components are less likely to damage human eyes. Therefore, a conventional illumination apparatus has been configured, in consideration of safety of human eyes, such that laser beams emitted from a laser light source are shielded. Such a configuration has made it difficult to increase a color temperature of illumination light by use of the laser beams. Usage of a blue fluorescent material makes it possible to theoretically increase the color temperature of illumination light. However, the blue fluorescent material, which has a high emission efficiency and is suitable for an illumination apparatus including a semiconductor laser, has been hard to find. As such, it has been difficult to increase the color temperature of illumination light by use of the blue fluorescent material. That is, the conventional illumination apparatus including, as an excitation light source, the semiconductor laser has had difficulty in increasing the color temperature of illumination light. Inventors of the present invention found in view of such circumstances that it was possible to increase the color temperature of illumination light by (i) shielding coherent components included in the laser beams and (ii) emitting outside incoherent components of blue components as well as light emitted from a light emitting section.

In a case where a semiconductor laser is used as a laser light source, coherent components included in laser beams are present only in the vicinity of a peak wavelength of the laser beams (mainly in a wavelength range of peaks of oscillation wavelengths), whereas incoherent components are electroluminescence (EL) components included in a peripheral wavelength domain of the vicinity of the peak wavelength. For example, in a case of a conventional semiconductor laser, a wavelength range in which the wavelengths of coherent components fall is on the order of a half bandwidth of a peak wavelength (for example, not more than 5 nm). Meanwhile, in a case of a semiconductor laser having broader peak wavelengths (peaks of emission light), the coherent components can be included merely in a wavelength range narrower than the half bandwidth of the peak wavelength. That is, the coherent components are included in the wavelength range of the vicinity of the peak wavelength of the laser oscillation, and the wavelength range is very narrow.

An illumination apparatus of the present invention was made on the basis of such a technical idea. The illumination apparatus not only can shield coherent components included (i) in exciting light having a bluish purple oscillation wavelength and (ii) in an extremely narrow wavelength range but also can emit outside incoherent components included (a) in the exciting light and (b) in a wavelength range broader than that including the coherent components. This allows an increase in color temperature of illumination light.

This embodiment exemplifies, as the illumination apparatus in accordance with an embodiment of the preset invention, a headlamp (illumination apparatus or vehicular headlamp) 1 that meets standards of a light distribution property of an automotive headlamp (high beam). Note, however, that the illumination apparatus of the present invention is not limited to this embodiment. The illumination apparatus of the present invention is applicable to (i) a headlamp that meets standards of a light distribution property of an automotive low-beam headlamp (low beam), (ii) a headlamp of vehicles other than an automobile or a movable object such as human, ship, aircraft, submarine or rocket or (iii) other illumination apparatus such as a searchlight.

(Configuration of Headlamp 1)

The following describes a configuration of a headlamp 1 in accordance with the present embodiment with reference to FIG. 1. FIG. 1 is a view schematically showing the configuration of the headlamp 1 in accordance with the present embodiment. As shown in FIG. 1, the headlamp 1 includes a semiconductor laser 2 (excitation light source), an aspheric lens 3, a light guiding section 4, a light emitting section 5, a reflector 6 and a transmission filter 7.

(Semiconductor Laser 2)

The semiconductor laser 2 functions as an excitation light source for emitting exciting light. The headlamp 1 can include a single semiconductor laser 2, alternatively can include a plurality of semiconductor lasers 2. Further, a semiconductor laser 2 in which each chip has a single light emitting point can be used, alternatively a semiconductor laser 2 in which each chip has a plurality of light emitting points can be used. In the present embodiment, the semiconductor laser 2 in which each chip has a single light emitting point is used.

For example, the semiconductor laser 2 in which each chip has a single light emitting point (one stripe) has an optical output of 1.0-watt, emits laser beams having an oscillation wavelength of 405 nm (bluish purple), and operates at 5 V and 0.7 A. The semiconductor laser 2 is sealed in a package (stem) having a diameter of 5.6 mm. In the present embodiment, 10 (ten) semiconductor lasers 2 are used. That is, the headlamp 1 has a total optical output of 10 W. Note, however, that only one of the 10 semiconductor lasers 2 is shown in FIG. 1 for the sake of convenience.

In a case where an excitation light source including a plurality of semiconductor lasers 2 is used to carry out an excitation at high power, it is preferable to shield laser beams whose wavelengths fall within a range of wavelengths which are not more than the vicinity of a longest peak wavelength among a plurality of peak wavelengths, and to emit outside laser beams (incoherent components) whose wavelengths are longer than the vicinity of the longest peak wavelength and are included on the periphery of the vicinity of the longest peak wavelength. This is because coherent components, whose wavelengths fall in a range of wavelengths in the vicinity of any of peak wavelengths, are prevented from leaking outside due to a slight error in peak wavelengths which is caused by the fact that the peak wavelengths of laser beams emitted from respective semiconductor lasers, in general, vary from semiconductor laser to semiconductor laser. Since a peak wavelength to be emitted outside is thus selected so that light emitted from the light emitting section 5 and incoherent components of blue components are emitted outside, it is possible to increase the color temperature of illumination light even in a case where the plurality of semiconductor lasers 2 included in the excitation light source emit light having different peak wavelengths. In this case, the transmission filter 7 (later described) for shielding the laser beams whose wavelengths fall within a range of wavelengths which are not more than the vicinity of the longest peak wavelength is used.

The oscillation wavelength of the semiconductor laser 2 is not limited to 405 nm. The semiconductor laser 2 can preferably have an oscillation wavelength which falls within a range from 400 nm to 460 nm, and can more preferably have a peak wavelength (peak wavelength of oscillation spectrum) which falls within a range from 400 nm to 420 nm. In other words, the semiconductor laser 2 emits exciting light having a bluish purple oscillation wavelength. This allows the headlamp 1 to emit outside light containing blue components.

In a case where the semiconductor laser 2 has an oscillation wavelength which falls within a range from 400 nm to 420 nm, it is possible to broaden the range of choice for a second fluorescent material used in combination with a first fluorescent material (having a peak wavelength of emission spectrum which peak falls within a range from 500 nm to 520 nm) so as to form the light emitting section 5 that emits white light. Specifically, it becomes possible to use, as the second fluorescent material, a fluorescent material having a peak wavelength of emission spectrum which peak wavelength falls within a range from 600 nm to 680 nm.

According to the present embodiment, the color temperature is increased by outward emission of incoherent components included in laser beams, that is, blue components included in the laser beams. In a case where the semiconductor laser 2 emits laser beams having an oscillation wavelength of less than 380 nm, the incoherent components are preferably visible light.

In a case where an oxynitride fluorescent material or a nitride fluorescent material is used as the fluorescent material of the light emitting section 5, it is preferable that (i) the semiconductor laser 2 have an optical output of not less than 1 W but not more than 20 W and (ii) the light emitting section 5 be irradiated with the laser beams having a light concentration which falls within a range from 0.1 W/mm² to 50 W/mm². In this case, it is possible to (a) achieve the light flux and the luminescence that are required for a vehicular headlamp and (b) prevent the light emitting section 5 from being extremely deteriorated by laser beams having a high optical output. That is, it is possible to provide a light source having high light flux and high luminescence while securing a longer operating life. In order to increase the color temperature of illumination light (in order to emit plenty of incoherent components), it is preferable to raise an optical output of whole exciting light. Alternatively, the color temperature of illumination light can also be increased by modifying a configuration of the semiconductor laser 2.

Note that the laser beams with which the light emitting section 5 is irradiated can have a light concentration of more than 50 W/mm² in a case where a semiconductor nanoparticle fluorescent material (later described) is used as the fluorescent material of the light emitting section 5.

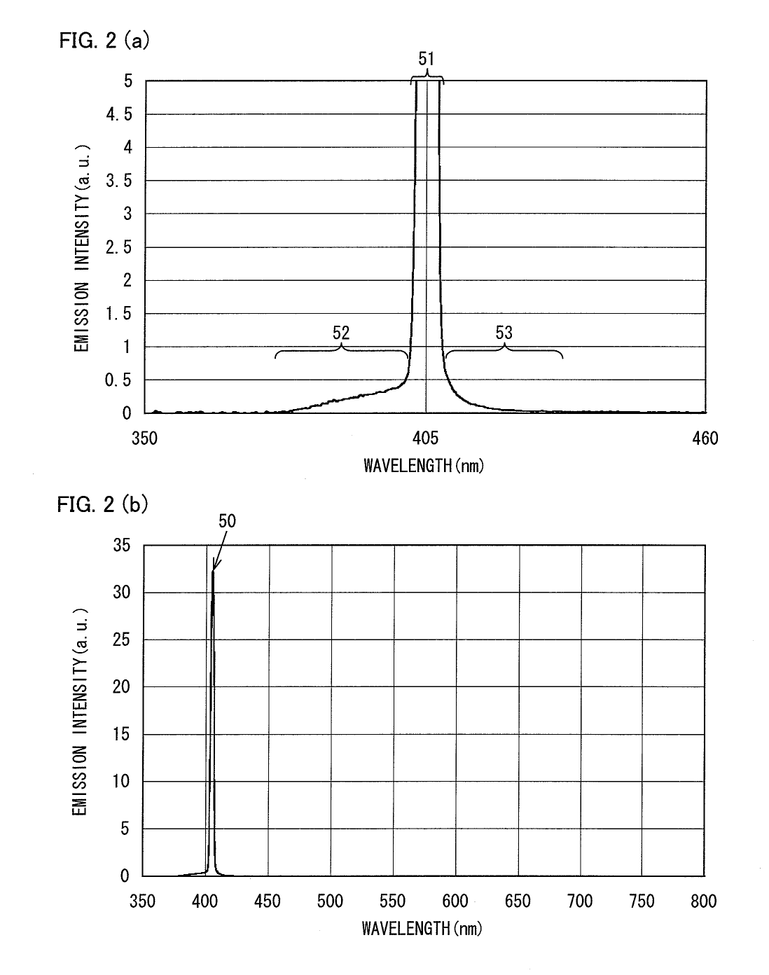

The following describes in detail components of laser beams with reference to FIGS. 2(a) and 2(b). FIGS. 2(a) and 2(b) are views showing the components of laser beams. Specifically, FIG. 2(a) is a graph showing how an emission spectrum of the laser beams emitted from the semiconductor laser 2 is distributed in a wavelength range from 350 nm to 460 nm, and FIG. 2(b) is a graph showing how the emission spectrum of the laser beams is distributed in an entire wavelength range of visible light.

FIG. 2(b) shows an emission spectrum in a case where a peak of an emission intensity of the laser beams emitted from the semiconductor laser 2 falls in the vicinity of 405 nm. In this case, an emission spectrum that has a very strong emission intensity in the vicinity of 405 nm is detected. Note that, as shown in FIG. 2(a), the laser beams are distributed so as to have (i) a first wavelength range 51 which corresponds to a center part of the emission spectrum 50 and in which emission intensity is very strong and (ii) second and third wavelength ranges 52 and 53 which correspond to skirts of the emission spectrum 50 and in which emission intensities are relatively weak. The laser beams having wavelengths in the first wavelength range 51 are coherent components that are likely to damage human eyes. In contrast, the laser beams having wavelengths in the second and third wavelength ranges 52 and 53 are incoherent components (EL emission components) that are less likely to damage human eyes. The first wavelength range 51 corresponds to a bluish purple range, and therefore blue components are contained in the incoherent components which are the laser beams whose wavelengths fall in the second and third wavelength ranges 52 and 53 on the both ends of the first wavelength range 51.

That is, the coherent components contained in the laser beams emitted from the semiconductor laser 2 are included mainly in the first wavelength range 51 that corresponds to a peak wavelength range (the vicinity of a peak wavelength) of oscillation wavelengths of the laser beams, and the peak wavelength range is very narrow. In contrast, the incoherent components are included in the second and third wavelength ranges 52 and 53 that are on both sides of the first wavelength range 51. The second and third wavelength ranges 52 and 53 are broader than the first wavelength range 51, as shown in FIG. 2(a). The headlamp 1 includes the transmission filter 7 (later described). The transmission filter 7 causes (i) the coherent components included in such a greatly narrow first wavelength range 51 to be shielded and (ii) broad incoherent components included in any one of the second and third wavelength ranges 52 and 53 that are on both sides of the first wavelength range 51 to be emitted outside. Since the headlamp 1 can thus emit outside light emitted from the light emitting section 5 and the incoherent components, it is possible to increase the color temperature of illumination light.

(Aspheric Lens 3)

The aspheric lens 3 is a lens through which laser beams emitted from the semiconductor laser 2 enter an incident surface 4a that is an end part of the light guiding section 4. For example, FLKN1 405 manufactured by ALPS ELECTRIC CO., LTD. can be used as the aspheric lens 3. However, a shape and a material of the aspheric lens 3 are not particularly limited, provided that the aspheric lens 3 has the above-described function. But yet, the aspheric lens 3 is preferably made from a heat-resistant material which greatly transmits a light beam having a wavelength of approximately 405 nm which is a wavelength of the exciting light.

The aspheric lens 3 converges laser beams emitted from the semiconductor laser 2 so as to guide the laser beams toward a relatively small incident surface (for example, a surface having a diameter of not more than approximately 1 mm). Therefore, in a case where the incident surface 4a of the light guiding section 4 is large enough for laser beams not to need to be converged, the aspheric lens 3 does not need to be provided.

(Light Guiding Section 4)

The light guiding section 4 is a light guiding member, having a truncated cone shape, for converging and guiding laser beams emitted from the semiconductor laser 2 toward the light emitting section 5 (a laser beam irradiated surface of the light emitting section 5). The light guiding section 4 is optically coupled to the semiconductor laser 2 via the aspheric lens 3 or directly. The light guiding section 4 includes (i) the incident surface 4a (an incident end part) for receiving the laser beams emitted from the semiconductor laser 2 and (ii) a light emitting surface 4b (light emitting end part) from which the laser beams received by the incident surface 4a is emitted toward the light emitting section 5.

The light emitting surface 4b has an area smaller than that of the incident surface 4a. This causes the laser beams that enter the incident surface 4a to be converged by traveling toward the light emitting surface 4b while being reflected from an inner side surface of the light guiding section 4 and then to be emitted from the light emitting surface 4b.

The light guiding section 4 is made from BK7 (borosilicate crown glass), quartz glass, acrylic resin or other transparent materials. The incident surface 4a and the light emitting surface 4b can be planar or curved.

Further, the light guiding section 4 are not limited to a specific one, and can therefore have a truncated pyramid shape or the light guiding section 4 can be optical fiber, provided that it guides, toward the light emitting section 5, the laser beams emitted from the semiconductor laser 2. Alternatively, the light emitting section 5 can be irradiated, via the aspheric lens 3 or directly, with the laser beams emitted from the semiconductor laser 2 instead of providing the light guiding section 4 in the headlamp 1. Specifically, in a case where the semiconductor laser 2 is not far from the light emitting section 5, the light guiding section 4 does not need to be provided in the headlamp 1.

According to the present embodiment, the transmission filter 7 (later described) transmits the incoherent components contained in the laser beams emitted from the semiconductor laser 2. That is, the light emitting section 5 does not need to convert or scatter all of the laser beams. Accordingly, the light emitting section 5 does not need to be irradiated with all of the laser beams. This makes it unnecessary to provide the aspheric lens 3 and/or the light guiding section 4 even in a case where a distance between the semiconductor laser 2 and the light emitting section 5 is not short. In addition, the area of the light emitting surface 4b can be larger than that of the laser beam irradiated surface of the light emitting section 5, the laser beam irradiated surface facing the light emitting surface 4b.

(Composition of Light Emitting Section 5)

The light emitting section 5 emits light in while being irradiated with the laser beams emitted from the light emitting surface 4b of the light guiding section 4. In the light emitting section 5, plural types of fluorescent materials, which emit light while being irradiated with laser beams, are dispersed in fluorescent material retention materials (sealing materials). Specifically, the light emitting section 5 includes a first fluorescent material, and a second fluorescent material having a peak of emission spectrum different from that of the first fluorescent material. The first fluorescent material has, for example, a peak of emission spectrum which peak falls within a range from 500 nm to 520 nm (particularly the vicinity of 510 nm). The second fluorescent material has, for example, a peak of emission spectrum which peak falls within a range from 600 nm to 680 nm (particularly the vicinity of 640 nm).

The above-described configuration makes it possible to provide an illumination apparatus including the light emitting section 5 for emitting white light, by using the laser beams, having bluish purple oscillation wavelengths, which are emitted from the semiconductor laser 2, in combination with the first and second fluorescent materials. According to the foregoing Purkinje phenomenon, human eyes most sensitively sense light having a wavelength of 507 nm in scotopic vision. According to the above-described configuration, the light emitting section 5 includes, as the first fluorescent material, a fluorescent material having a peak of emission spectrum which peak falls in the vicinity of 510 nm. This allows the headlamp 1 to have an increased spectral luminous efficiency even in a surrounding dark environment.

Each of the first and second fluorescent materials is an oxynitride fluorescent material, a nitride fluorescent material or a semiconductor nanoparticle fluorescent material made from particles of a III-V compound semiconductor, which particles have a size of nanometer.

A typical example of the oxynitride fluorescent material is a commonly called SiAlON (silicone aluminum oxynitride) fluorescent material. In the SiAlON fluorescent material, some silicon atoms of silicon nitride are replaced with aluminum atoms, and some nitrogen atoms of the silicon nitride are replaced with oxygen atoms. The SiAlON fluorescent material can be prepared by dissolving alumina (Al₂O₃), silica (SiO₂), a rare earth element and the like in silicon nitride (Si₃N₄) so as to form a solid solution thereof. The first fluorescent material is, for example, a Caα-SiAlON: Ce³⁺ fluorescent material (Caα-SiAlON: Ce fluorescent material). The second fluorescent material is, for example, a CaAlSiN₃: Eu²⁺ fluorescent material (CASN: Eu fluorescent material) that is a nitride fluorescent material.

In a case where an excitation wavelength is 405 nm, the Caα-SiAlON: Ce fluorescent material emits blue through green fluorescence having a peak wavelength of fluorescence spectrum of 510 nm. The Caα-SiAlON: Ce fluorescent material has a high emission efficiency of 65%. Furthermore, the Caα-SiAlON: Ce fluorescent material is excellent in heat resistance. Therefore, the light emitting section 5 is less likely to be deteriorated even in a case where it is irradiated with laser beams having high optical output and high light concentration. Similarly, in the case where the excitation wavelength is 405 nm, the CASN: Eu fluorescent material emits red fluorescence having a peak wavelength of fluorescence spectrum of 650 nm. The CASN: Eu fluorescent material has a high emission efficiency of 73%. Furthermore, the CASN: Eu fluorescent material is also excellent in heat resistance. Therefore, the light emitting section 5 is less likely to be deteriorated by irradiation even in the case where it is irradiated with laser beams having high optical output and high concentration. It is thus possible to provide a headlamp that emits white light having high luminescence and high light flux by using these fluorescent materials as the first and second fluorescent materials.

A feature of the semiconductor nanoparticle fluorescent material resides in that, even in a case where a compound semiconductor (for example, indium phosphide: InP) is used, an emission color can be changed by a quantum size effect which is obtained by changing a particle size of such a compound semiconductor into a nanometer particle size. For example, InP, having a particle size of the order of 3 nm to 4 nm, emits red light. Note that the particle size is evaluated by a transmission electron microscope (TEM).

The semiconductor nanoparticle fluorescent material is made from a semiconductor. Therefore, the semiconductor nanoparticle fluorescent material has a short luminescence life, and can quickly emit a power of exciting light as fluorescence. This allows the semiconductor nanoparticle fluorescent material to also have a strong resistance to the exciting light having high power. This is because the semiconductor nanoparticle fluorescent material has an emission life of as short as approximately 10 nanoseconds, which is 5 digits shorter than that of a normal fluorescent material in which rare earth is luminescence center.

As described above, the semiconductor nanoparticle fluorescent material has a short emission life. Therefore, the semiconductor nanoparticle fluorescent material can quickly and repetitively carry out absorption of laser beams and emission of fluorescence. This allows the semiconductor nanoparticle fluorescent material to retain a high conversion efficiency with respect to strong laser beams, and to reducing heat generated by the semiconductor nanoparticle fluorescent material. Hence, a deterioration (change in color and/or deformation) in the light emitting section 5 due to heat can be further suppressed. This allows the headlamp 1 to extend its operating life.

The sealing material can be made from a resin such as silicone resin or a glass material such as inorganic glass or organic hybrid glass. Note that the light emitting section 5 can be prepared by pressing and hardening merely the fluorescent material. Meanwhile, it is preferable that the light emitting section 5 is prepared by dispersing the fluorescent material in the sealing material. This is because the deterioration in the light emitting section 5, caused by irradiation of the light emitting section 5 with laser beams, is likely to be accelerated in a case where the light emitting section 5 is prepared by pressing and hardening merely the fluorescent material.

(Arrangement and Shape of Light Emitting Section 5)

The light emitting section 5 is fixed to a focal point of the reflector 6 or in the vicinity of the focal point inside the transmission filter 7 (on a side where the light emitting surface 4b is located). However, how to fix the light emitting section 5 is not limited to this. Alternatively, the light emitting section 5 can be fixed by a rod-like or tubular member that extends from the reflector 6.

A shape of the light emitting section 5 is not limited to a specific one. The shape of light emitting section 5 can be a rectangular parallelepiped or columnar shape. The light emitting section 5 of the present embodiment is columnar with a diameter of 2 mm and a thickness (height) of 1 mm. A laser beam irradiated surface of the light emitting section 5, which is irradiated with laser beams, is not necessarily planar and can therefore be curved. However, the laser beam irradiated surface is preferably planar so as to be perpendicular to an axis of the laser beams, in view of controlling of reflection of the laser beams. In a case where the laser beam irradiated surface is curved, at least angles at which the laser beams enter greatly differ from location to location. This causes a direction, in which reflected laser beams travel, to greatly differ depending on where the laser beams are irradiated. As such, it is sometimes difficult to control the direction in which the laser beams are reflected. In contrast, in a case where the laser beam irradiated surface is planar, the direction in which reflected laser beams travel is almost the same even in a case where a location to be irradiated with the laser beams slightly deviates. This makes it easy to control the direction in which the laser beams are reflected. In some cases, it becomes easier to take measures such as providing of an absorbent member in a place to be irradiated with reflected laser beams.

The thickness of the light emitting section 5 is not limited to 1 mm. A requisite thickness of the light emitting section 5 changes depending on a ratio between a sealant and a fluorescent material in the light emitting section 5. In a case where the content of the fluorescent material increases in the light emitting section 5, an efficiency at which laser beams are converted into white light is increased. This allows a reduction in the thickness of the light emitting section 5.

The headlamp 1 of the present embodiment is configured to emit outside incoherent components included in the laser beams emitted from the semiconductor laser 2. The light emitting section 5 preferably has a thickness that causes the laser beams to transmit to an extent that incoherent components leak out without the light emitting section 5 not converting all of the laser beams into white light or without the light emitting section 5 not sufficiently scattering the laser beams. Note that, in a case where the headlamp 1 is configured such that the light emitting section 5 is not irradiated with part of the laser beams, it is not necessarily to determine the thickness of the light emitting section 5 in consideration of the incoherent components. Quantity of the laser beams that transmit the light emitting section 5 is determined by adjustment of an optical output of the semiconductor laser 2 as well as the thickness of the light emitting section 5.

(Reflector 6)

The reflector 6 has an opening, forms a bundle of light beams that travels within a predetermined solid angle by reflecting incoherent light emitted by the light emitting section 5, and then emits the bundle of light beams via the opening. That is, the reflector 6 forms the bundle of light beams that travels ahead of the headlamp 1, by reflecting light emitted from the light emitting section 5. The reflector 6 is, for example, a curved (cupped) member on which surface a metal thin film is formed, and has the opening in the direction where reflected light travels.

The reflector 6 is not limited to a semispherical mirror. Alternatively, the reflector 6 can be an elliptical mirror, a parabolic mirror or a mirror partially having an elliptical or parabolic surface. That is, the reflector 6 can have a reflection surface that is at least part of a curved surface obtained by rotating a graphic (ellipse, circle or parabola) about a rotation axis. A shape of the opening of the reflector 6 is not limited to a circular form. The shape of the opening can be determined as appropriate in accordance with the headlamp 1 and a peripheral design of the headlamp 1.

(Transmission Filter 7)

The transmission filter 7 is a transparent resin plate (a resin plate for selectively transmitting light having a predetermined wavelength domain) that covers the opening of the reflector 6. The transmission filter 7 holds the light emitting section 5. The transmission filter 7 is preferably made from a material for shielding the coherent components included in the laser beams emitted from the semiconductor laser 2 and for transmitting the incoherent components included in the laser beams and white light into which the light emitting section 5 converts the laser beams.

In the photopic vision, sensitivity of human eyes becomes highest to light having a wavelength of 555 nm. Meanwhile, in the scotopic vision, the sensitivity of human eyes becomes highest to light having a wavelength of 507 nm. Two wavelength ranges in which wavelengths of the incoherent components included in the laser beams fall on a short wavelength side (see the second wavelength range 52 of FIG. 2(a)) of and on a long wavelength side (see the third wavelength range 53 of FIG. 2(a)) of a wavelength range in which wavelengths of coherent components included in the laser beams fall.

In view of the circumstances, it is preferable that the transmission filter 7 transmit at least light, among the incoherent components, which has a wavelength longer than those of the coherent components. In this case, among the incoherent components included in the laser beams, the transmission filter 7 transmits incoherent components whose wavelengths fall in the wavelength range on the long wavelength side (i.e., light having a wavelength longer than those of the coherent components). This allows the headlamp 1 to emit light whose spectral luminous efficiency is similar to the above one (555 nm or 507 nm) among the incoherent components whose wavelengths fall in the wavelength range on the long wavelength side or the short wavelength side. It is therefore possible to improve the spectral luminous efficiency in both photopic vision and scotopic vision.

The transmission filter 7 is required to transmit light having a wavelength of not less than 408 nm (i.e., shields light having a wavelength of less than 408 nm) in a case where the semiconductor laser 2 emits laser beams having a peak wavelength of 405 nm and a half bandwidth of 5 nm. In this case, it is possible to use, as illumination light, incoherent components, among laser beams, whose wavelengths fall in a wavelength range of not less than 408 nm. For example, ITY408 manufactured by Isuzu Glass Co., Ltd. can be used as the transmission filter 7.

As described above, the Caα-SiAlON: Ce fluorescent material emits light having a peak wavelength of fluorescence spectrum of 510 nm, and the sensitivity of human eyes becomes highest to light having a wavelength of 507 nm in the scotopic vision. Therefore, in a case where an illumination apparatus such as the headlamp 1 that is used in a surrounding dark environment employs the Caα-SiAlON: Ce fluorescent material as the light emitting section 5, the spectral luminous efficiency in scotopic vision can be improved, and therefore the illumination apparatus can improve its commercial value.

Coherent components included in laser beams are likely to damage human eyes. In view of the circumstances, a conventional illumination apparatus has been designed such that exciting light emitted from an excitation light source does not leak outside the illumination apparatus. This allows safety of particularly human eyes to be maximally secured. The conventional illumination apparatus shields laser beams emitted from a semiconductor laser in consideration of the safety. This made it difficult to increase a color temperature of illumination light by use of the laser beams.

Meanwhile, usage of a blue fluorescent material makes it possible to theoretically increase the color temperature of illumination light. However, the blue fluorescent material, which has a great light emitting efficiency and is suitable for an illumination apparatus including a semiconductor laser, has been hard to find. As such, it has been difficult to increase the color temperature of illumination light by use of the blue fluorescent material. In a case where the Caα-SiAlON: Ce fluorescent material is used as a fluorescent material, it is difficult to emit white light having a high color temperature because the Caα-SiAlON: Ce fluorescent material has a peak wavelength of over 500 nm, and therefore a color of light emitted from the Caα-SiAlON: Ce fluorescent material contains less blue components.

Specifically, the Caα-SiAlON: Ce fluorescent material has a peak wavelength of 510 nm in a case where an excitation wavelength is 405 nm. Therefore, for example, the CASN: Eu fluorescent material having a peak wavelength of 650 nm is used in combination with the Caα-SiAlON: Ce fluorescent material so that white light having a high color temperature is emitted. It is assumed here that a light emitting section including these fluorescent materials is irradiated with laser beams having an oscillation wavelength of 405 nm by a semiconductor laser, all of the laser beams are converted into fluorescence or scattered by the light emitting section, and merely fluorescence emitted from the light emitting section is employed as illumination light (all of the laser beams emitted from the semiconductor laser are shielded).

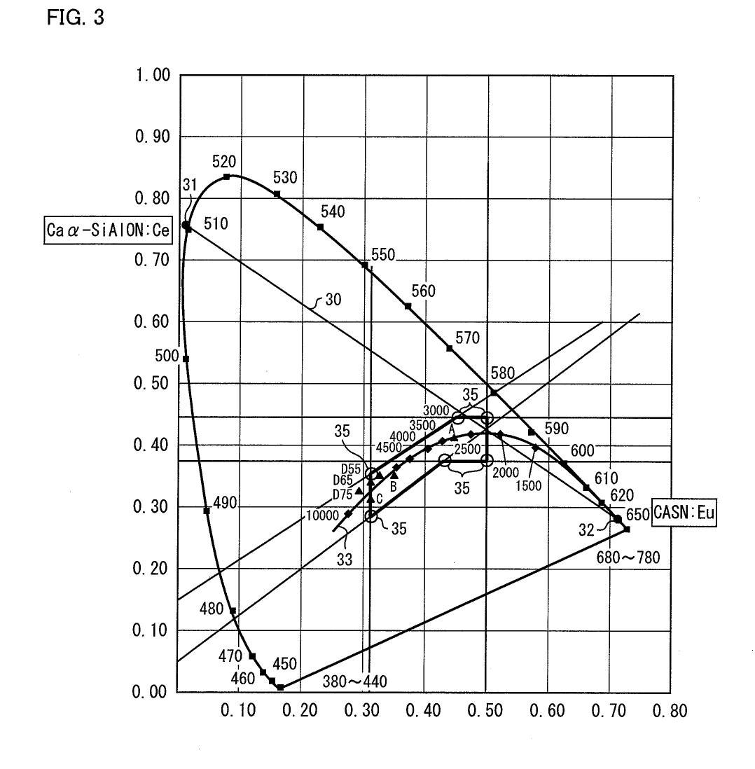

Under the assumption, a color (chromaticity) of the illumination light is only on the straight line 30 defined by (i) a dot 31 indicating the peak wavelength of the Caα-SiAlON: Ce fluorescent material and (ii) a dot 32 indicating the peak wavelength of the CASN: Eu fluorescent material (see FIG. 3).

FIG. 3 is a graph (chromaticity diagram) showing a chromaticity range of white required for a vehicular headlamp. As shown in FIG. 3, the chromaticity range of white required for the vehicular headlamp is required by law. The chromaticity range is in a polygon defined by six apexes 35. A curved line 33 shows a color temperature (K: Kelvin).

Even in a case where, as shown in FIG. 3, the ratio of the Caα-SiAlON: Ce fluorescent material and the CASN: Eu fluorescent material is adjusted so that white light corresponding to inside of the polygon is emitted, the light emitting section merely emits white light having a color temperature of the order of 2000 K to 3500 K (extremely low color temperature of the order of bulb light color). That is, an illumination apparatus employing laser beams as exciting light has difficulty in emitting white light having a high color temperature. Note that the color temperature may range slightly broader than a theoretical value because emission spectrums of the Caα-SiAlON: Ce fluorescent material and the CASN: Eu fluorescent material have their respective half bandwidths.

That is, it is difficult for the combination of the Caα-SiAlON: Ce fluorescent material and the CASN: Eu fluorescent material to increase the color temperature of the illumination light. In a case where the laser beams are used as exciting light as described above, the illumination apparatus is designed such that the laser beams do not leak outside, so that safety of human bodies is secured, as described above. This design makes it difficult to increase the color temperature of illumination light by use of the laser beams. In a field, such as a vehicular headlamp, in which white light having a high color temperature is required, an illumination apparatus capable of emitting white light having such a high color temperature has been required.

The headlamp 1 of the present embodiment includes the transmission filter 7 for transmitting incoherent components included in laser beams having a bluish purple oscillation wavelength, which are emitted from the semiconductor laser 2. The transmission filter 7 does not shield all of the laser beams emitted from the semiconductor laser 2 but shields merely laser beams having a wavelength (the wavelength and a (nm)) of coherent components. The incoherent components (which can include coherent components reduced to an extent that human bodies are not damaged) which have transmitted the transmission filter 7 are used as part of illumination light.

This allows the headlamp 1 to emit not only light emitted from the light emitting section 5 but also light that (i) leaks out from the light emitting section 5 (or that is not emitted to the light emitting section 5), (ii) has a wavelength which falls in the vicinity of the bluish purple wavelength range, and (iii) has a high color temperature. Hence, the headlamp 1 can emit white light having an increased color temperature.

As described above, the transmission filter 7 shields the coherent components included in laser beams, whereas transmits the incoherent components included in the laser beams. The coherent components are likely to damage human eyes. In contrast, the incoherent components are less likely to damage human eyes. It is therefore possible to prevent the human eyes from being damaged by illumination light emitted from the headlamp 1. That is, the safety of the human eyes can be secured while the color temperature is increased.

Note, however, that the transmission filter 7 does not necessarily shield all harmful coherent components and transmit all harmless incoherent components. That is, the transmission filter 7 does not necessarily shield all of the harmful coherent components, provided that a transmitting amount of the harmful coherent components is not more than a secure level. Further, the transmission filter 7 does not necessarily transmit all of the harmless incoherent components, provided that it can transmit the incoherent components enough to increase the color temperature.

(Configuration of Semiconductor Laser 2)

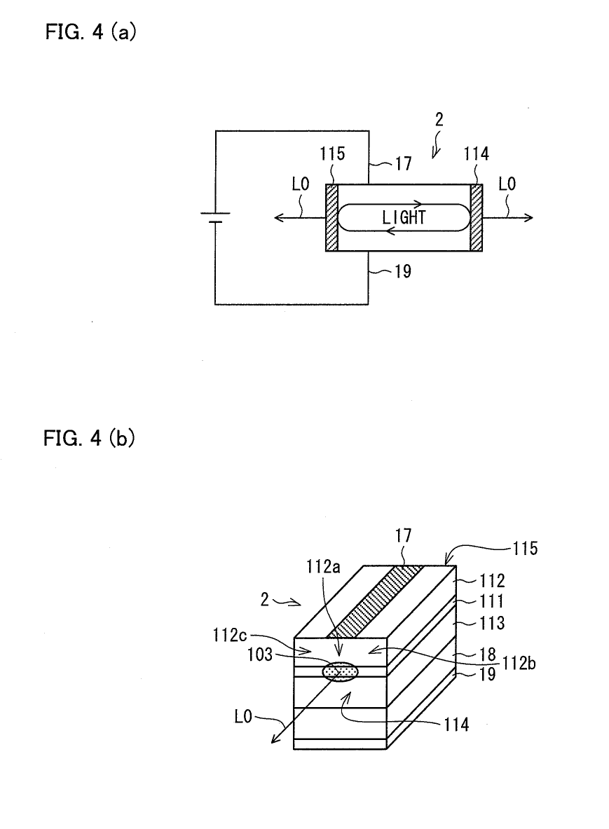

The following describes a basic configuration of the semiconductor laser 2. FIG. 4(a) is a view schematically showing a circuit of the semiconductor laser 2. FIG. 4(b) is a perspective view showing a basic configuration of the semiconductor laser 2. As shown in FIG. 4(b), the semiconductor laser 2 includes a cathode electrode 19, a substrate 18, a clad layer 113, an active layer 111, a clad layer 112, and an anode electrode 17 that are laminated in this order.

The substrate 18 is preferably a semiconductor substrate made from GaN, sapphire or SiC so that blue through ultraviolet exciting light that excites the fluorescent material is generated in the present embodiment. Other examples of the substrate 18 of the semiconductor laser encompass (i) a IV semiconductor such as Si, Ge or Sic, (ii) a III-V compound semiconductor such as GaAs, GaP, InP, AlAs, GaN, InN, InSb, GaSb or AlN, (iii) a II-VI compound semiconductor such as ZnTe, ZeSe, ZnS or ZnO, (iv) an oxide insulator such as ZnO, Al₂O₃, SiO₂, TiO₂, CrO₂ or CeO₂, and (v) a nitride insulator such as SiN.

The anode electrode 17 injects electric current into the active layer 111 via the clad layer 112.

The cathode electrode 19 injects electric current into the active layer 111 via the clad layer 113 from a lower part of the substrate 18. Note that the injection of the electric current into the active layer 111 is carried out by applying a forward bias to the anode electrode 17 and the cathode electrode 19.

The active layer 111 is sandwiched between the clad layer 113 and the clad layer 112.

The active layer 111 and the clad layers are made from a mixed crystal semiconductor of AlInGaN so that blue through ultraviolet exciting light is generated. Generally, an active layer and clad layers of a semiconductor laser are made from a mixed crystal semiconductor containing Al, Ga, In, As, P, N, and Sb as main components. The active layer 111 and the clad layers 112 and 113 of the present embodiment can be made from the mixed crystal semiconductor containing Al, Ga, In, As, P, N, and Sb as main components. Alternatively, the active layer 111 and the clad layers 112 and 113 can be made from Zn, Mg, S, Se, Te and a II-VI compound semiconductor such as ZnO.

The active layer 111 is a region where light is generated by injection of electric current into the active layer 111. The light generated in the region is confined in the active layer 111 due to a difference in refractivity between the active layer 111 and the clad layers 112 and 113.

The active layer 111 includes a front-side cleavage surface 114 and a backside cleavage surface 115, which face each other, provided so that light amplified by stimulated emission is confined in the active layer 111. The front-side cleavage surface 114 and the backside cleavage surface 115 serve as respective mirrors.

Note, however, that the front-side cleavage surface 114 and the backside cleavage surface 115 do not completely reflect light, unlike a mirror. Some of the light amplified by the stimulated emission is emitted as laser beams (exciting light) L0 from the front-side cleavage surface 114 and the backside cleavage surface 115 of the active layer 111 (in the present embodiment, for the sake of convenience, from the front-side cleavage surface 114). Note that the active layer 111 can have a multilayered quantum well structure.

The backside cleavage surface 115 facing the front-side cleavage surface 114 has a reflection film (not shown) for laser oscillation. This causes a difference in reflectivity between the front-side cleavage surface 114 and the backside cleavage surface 115. Such a difference in reflectivity allows most of the laser beams (exciting light) L0 to be emitted, via a light emitting point 103, for example, from the front-side cleavage surface 114 that is a low reflectivity end surface.

The clad layer 113 and the clad layer 112 can be made from an n-type semiconductor and a p-type semiconductor, respectively, or vice versa, provided that electric current can be injected into the active layer 111 through the clad layers 113 and 112 by applying a forward bias to the anode electrode 17 and the cathode electrode 19. Examples of the semiconductor encompass (i) a III-V compound semiconductor such as GaAs, GaP, InP, AlAs, GaN, InN, InSb, GaSb or AlN and (ii) a II-VI compound semiconductor such as ZnTe, ZeSe, ZnS or ZnO.

Semiconductor layers such as the clad layers 113 and 112 and the active layer 111 can be deposited by a general deposition technique such as an MOCVD (metalorganic chemical vapor deposition) method, an MBE (molecular beam epitaxy) method, a CVD (chemical vapor deposition) method, a laser ablation method or a sputtering method. Metal layers of the semiconductor laser 2 can be deposited by a general deposition technique such as a vacuum evaporation method, a plating technique, a laser ablation method or a sputtering method.

(Concrete Example of the Configuration of the Semiconductor Laser 2)

As described above, the light generated is confined in the active layer 111 due to the active layer 111 and the difference in refractivity between the clad layers 112 and 113. In order to emit laser beams having a high emission intensity, not only light in a (longitudinal) direction of the front-side cleavage surface 114 in which direction layers constituting the semiconductor laser 2 are laminated but also light in a (lateral) direction of the front-side cleavage surface 114 which direction is perpendicular to the direction in which the layers constituting the semiconductor laser 2 are laminated should be confined in the active layer 111. This is because the light is broad in the lateral direction. As such, the semiconductor laser 2 controls not only the light in the longitudinal direction but also the light in the laterally direction.

There are semiconductor lasers having respective various structures which allow the light to be controlled in the lateral direction. Examples of the structures encompass a real guide structure and a gain guide structure. The real guide can be called “refraction confinement” or the like. The gain guide can be called “gain waveguide”, “gain confinement”, “electric current confinement” or the like.

In a case where the semiconductor laser 2 is a semiconductor laser having the real guide structure (hereinafter referred to as a real guide semiconductor laser), the clad layer 112 includes a first region 112a (ridge part) that is an upper part of a region where the light emitting point 103 is to be located, and a second region 112b and a third region 112c that are located on both sides of the first region 112a, as shown in FIG. 4(b). The first region 112a is different in refractive index from the second region 112b and the third region 112c. Specifically, the first region 112a is made from a material (for example, a II-V compound semiconductor) identical to that of the clad layer 112. The second region 112b and the third region 112c are made from a material (for example, SiO₂ or zirconium oxide) having a refractive index smaller than that of the material for the first region 112a.

By employing such a difference in refractive index, the real guide semiconductor laser can inject electric current into the active layer 111 from the anode electrode 17 through only the first region 112a of the clad laser 112. This allows light to be confined directly below the first region 112a. It is therefore possible to reduce the light emitting point 103 in its size and to increase an optical output of the light emitted from the light emitting point 103. Note that a concrete description for the real guide semiconductor laser is omitted here because the real guide semiconductor laser is a well-known technique.

As described above, the real guide semiconductor laser is configured to confine light at the light emitting point 103 by employing the difference in refractive index between (i) the first region 112a and (ii) the respective second and third regions 112b and 112c. Therefore, the anode electrode 17 does not necessarily have a stripe-shaped electrode as shown in FIG. 4(b). Note that the real guide semiconductor laser has been described with reference to FIG. 4(b) but the real guide semiconductor laser shown in FIG. 4(b) shows a basic structure of a semiconductor laser 2 including variously structured semiconductor lasers capable of controlling light in the lateral direction of the front-side cleavage surface 114.

In a case where the semiconductor laser 2 is a semiconductor laser having the gain guide structure (hereinafter referred to as a gain guide semiconductor laser), the semiconductor laser 2 is not configured to confine light at the light emitting point 103 by employing the difference in reflective index as described above. In this case, if the anode electrode 17 is provided widely in the lateral direction, then electric current to be injected into the active layer 111 will also extend in the lateral direction (the light emitting point 103 will extend in the lateral direction). This makes it impossible to emit laser beams having a high emission intensity.

In order to address such a problem, the gain guide semiconductor laser is designed such that the anode electrode 17 is in a stripe shape (stripe electrode structure) having a width (that is, a narrow width) substantially equal to a width of a region where the light emitting point 103 is to be located, as shown in FIG. 4(b). This allows the light to be confined in the active layer 111 in response to the electric current injected from the anode electrode 17. An example of the stripe electrode structure is disclosed in a semiconductor laser apparatus of Japanese Patent Application Publication, Tokukaihei No. 5-175594 A (Publication Date: Jul. 13, 1993).

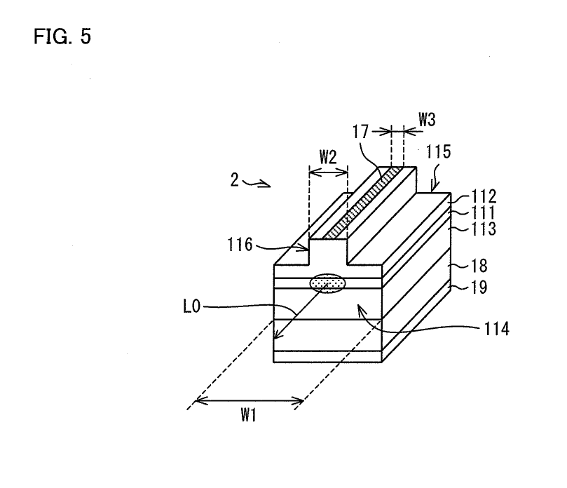

The gain guide semiconductor laser can be configured as shown in FIG. 5. FIG. 5 is a perspective view showing another example of a basic configuration of the gain guide semiconductor laser.

As shown in FIG. 5, the gain guide semiconductor laser is configured such that a ridge part 116 is provided on an upper surface of the clad layer 112, and a stripe-shaped anode electrode 17 having a lateral length shorter than that of the ridge part 116 is provided on an upper surface of the ridge part 116. Generally, electric current from an anode electrode 17 is injected into the active layer 111 while extending in a lateral direction even in a case where the anode electrode 17 is stripe-shaped. Therefore, by providing the ridge part 116 whose lateral length is shorter than that of the active layer 111 as shown in the configuration of FIG. 5, it is possible to suppress lateral extension of electric current injected from the anode electrode 17.

The semiconductor laser 2 can be the real guide semiconductor laser or the gain guide semiconductor laser. Alternatively, the semiconductor laser 2 can have another structure such as an index guide structure or a loss guide structure.

As described above, the real guide semiconductor laser achieves the confinement of light in the lateral direction by means of the difference in refractive index. This allows the real guide semiconductor laser to (i) have a smaller light emitting point 103 and (ii) emit laser beams having a high emission intensity, as compared with the gain guide semiconductor laser. This is because it is difficult for the gain guide semiconductor laser to suppress the extending of the electric current injected from the anode electrode 17 in the lateral direction. Hence, the real guide semiconductor laser has been currently used mainly in various fields such as an optical pickup for use in an apparatus for playing back an optical disk.

To put it the other way around, in the gain guide semiconductor laser, the electric current is injected into a region (a region distant from a center of the light emitting point 103) of the active laser 111 while extending in the lateral direction. This allows the gain guide semiconductor laser to emit more incoherent components from the region than the real guide semiconductor laser does.

The headlamp 1 of the present embodiment increases a color temperature of illumination light by employing, as part of the illumination light, incoherent components (blue components) included in laser beams emitted from the semiconductor laser 2. Therefore, the laser beams preferably contain plenty of incoherent components. In terms of this, the semiconductor laser 2 is preferably the gain guide semiconductor laser.

The gain guide semiconductor laser thus has a broader emission area where light is emitted, as compared with the real guide semiconductor laser. Therefore, in a case where the semiconductor laser 2 is the gain guide semiconductor laser, the semiconductor laser 2 can increase the incoherent components without improving its emission intensity.

In the case where the semiconductor laser 2 is the gain guide semiconductor laser, the clad layer 113 has a lateral length W1 of 200 μm, the ridge part 116 has a lateral length W2 of 30 μm to 100 μm, and the anode electrode 17 has a lateral length W3 of 10 μm to 20 μm, for example.

The clad layer 112 is preferably an n-type semiconductor. This is because the n-type semiconductor has a mobility greater than that of a p-type semiconductor. Such a greater mobility makes it possible to broadly inject electric current into the active layer 111 thereby increasing the number of incoherent components. Meanwhile, in a case where the clad layer 112 is the p-type semiconductor, the p-type semiconductor is preferably a highly doped p-type semiconductor (approximately 5×10¹⁷ cm⁻³ to 2×10¹⁸ cm⁻³) in consideration of the mobility.

(Principle of Light Emission of Light Emitting Section 5)

The following describes a principle of how a fluorescent material emits light by use of laser beams emitted from the semiconductor laser 2.

Firstly, the fluorescent material included in the light emitting section 5 is irradiated with laser beams emitted from the semiconductor laser 2. This causes electrons in the fluorescent material to be excited so that a transition occurs to a high energy state (excited state) from a low energy state.

Thereafter, a transition of the energy state of the electrons included in the fluorescent material to a low energy state (a ground level or a metastable level between an excited level and a ground level) occurs in a certain period of time. This is because the excited state of the electrons is unstable.

The transition of the energy state of the electrons from the high energy state to the low energy state causes the fluorescent material to emit light.

White light can be achieved by a color mixture of three colors that meet an isochromatic principle or by a color mixture of two colors that meet a complementary color relationship. The white light can be generated by combining a color of laser beams emitted from a semiconductor laser with a color of light emitted from a fluorescent material on the basis of the isochromatic principle or the complementary color relationship.

[Another Example of Headlamp]

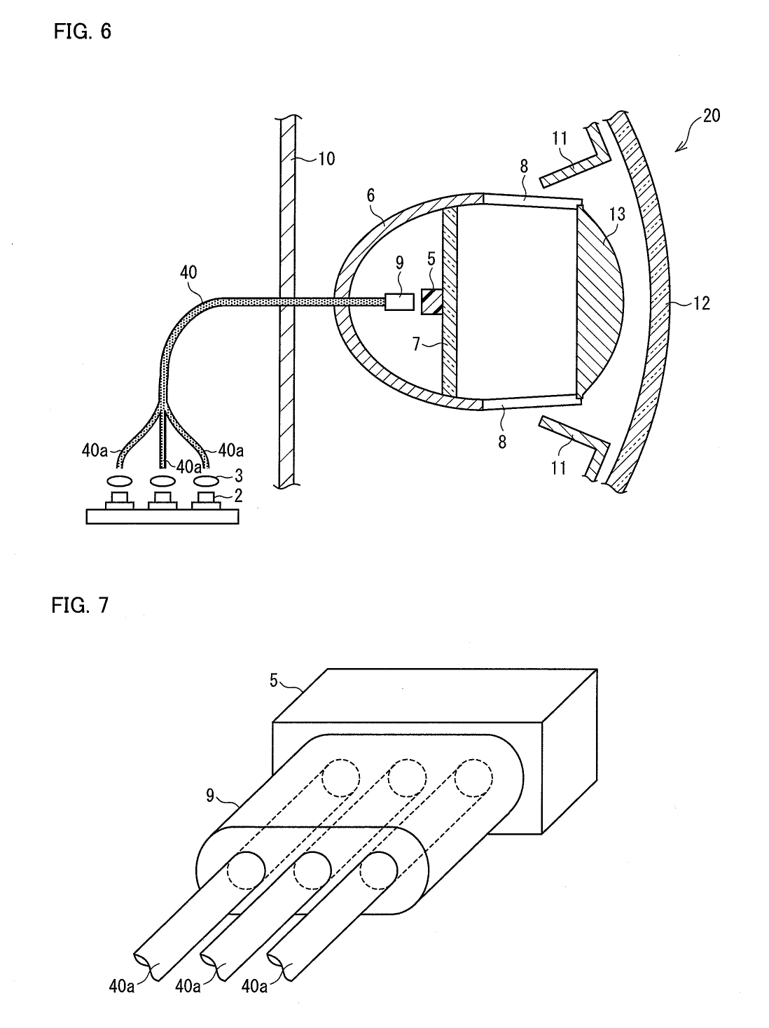

The following describes another example of the present embodiment with reference to FIG. 6. Note that like reference numerals herein refer to corresponding members of the headlamp 1, and descriptions of such members are omitted here. In this example, a projector headlamp 20 is described.

(Configuration of Headlamp 20)

Firstly, a configuration of the headlamp 20 in accordance with the present embodiment is described with reference to FIG. 6. FIG. 6 is a cross-sectional view showing a configuration of the headlamp 20 that is a projector headlamp. The headlamp 20 is different from the headlamp 1 in that the headlamp 20 is a projector headlamp and includes an optical fiber 40 instead of the light guiding section 4.

As shown in FIG. 5, the headlamp 20 includes a semiconductor laser 2, an aspheric lens 3, the optical fiber (light guiding section) 40, a ferrule 9, a light emitting section 5, a reflector 6, a transmission filter 7, a housing 10, an extension 11, a lens 12, a convex lens 13, and a lens holder 8. The semiconductor laser 2, the optical fiber 40, the ferrule 9, and the light emitting section 5 constitute a basic configuration of the headlamp 20.

The headlamp 20 is the projector headlamp, and therefore includes the convex lens 13. The present invention is applicable to another type of headlamp such as a semi-shield beam headlamp. In this case, the convex lens 13 does not need to be provided in the semi-shield beam headlamp.

(Aspheric Lens 3)

The aspheric lens 3 is a lens for causing laser beams (exciting light) emitted from the semiconductor laser 2 to enter an incident end part that is an end part of the optical fiber 40. The aspheric lens 3 is provided in the headlamp 20 so as to be equal in number to the optical fiber 40a.

(Optical Fiber 40)

The optical fiber 40 is a light guiding member for guiding, to the light emitting section 5, the laser beams emitted from the semiconductor laser 2, and is made up from a plurality of optical fibers 40a. The optical fiber 40 has a two layer structure in which a center core is surrounded by a clad whose refractivity is lower than that of the center core. The center core contains, as a main ingredient, quartz glass (silicon oxide) that causes very little absorption loss of the laser beams. The clad contains, as a main ingredient, quartz glass or a synthetic resin material that has refractivity lower than that of the center core.

For example, in the optical fiber 40 made from quartz, the core has a diameter of 200 μm, the clad has a diameter of 240 μm, and a numerical aperture NA is 0.02. However, a configuration, a diameter and a material of the optical fiber 40 are not limited to the above-described ones. Alternatively, the optical fiber 40 can have an oblong cross section perpendicular to a longitudinal direction of the optical fiber 40.

The optical fiber 40 includes a plurality of incident end parts where the laser beams are received, and a plurality of light emitting end parts from which the laser beams that have entered the incident end parts are emitted. The plurality of light emitting end parts are positioned, by the ferrule 9, so as to face a laser beam irradiated surface (light receiving surface) of the light emitting section 5, as later described.

(Ferrule 9)

FIG. 7 is a view showing a positional relationship of the light emitting end parts of the optical fibers 40a with the light emitting section 5. As shown in FIG. 7, the ferrule 9 holds the light emitting end parts of the optical fibers 40a in a predetermined pattern such that the light emitting end parts of the optical fibers 40a face the laser beam irradiated surface of the light emitting section 5. The ferrule 9 can be configured so as to have, in a predetermined pattern, through-holes through which the optical fibers 40a are inserted. Alternatively, the ferrule 9 can be configured (i) so as to have detachable upper and lower parts which are combined with each other via respective combining surfaces and have first and second grooves, respectively, and (ii) so that each of the optical fibers 40a is sandwiched between a corresponding one of the first grooves and a corresponding one of the second grooves.

A material for the ferrule 9 is not limited to a specific one. The ferrule 9 can be made from, for example, stainless steel. In FIG. 7, three optical fibers 40a are shown. However, the number of the optical fibers 40a is not limited to three. The ferrule 9 can be fixed by, for example, a rod-like member that extends from the reflector 6.

As described above, the ferrule 9 positions the light emitting end parts of the optical fibers 40a. This allows different regions of the laser beam irradiated surface of the light emitting section 5 to be irradiated with maximum light intensity parts of light intensity distributions of the laser beams emitted from the respective optical fibers 40a. It is therefore possible to prevent the light emitting section 5 from being extremely deteriorated because the laser beams are converged onto a single specific point of the light emitting section 5. The light emitting end parts can contact with the laser beam irradiated surface or can alternatively be provided to be away, by a slight interval, from the laser beam irradiated surface.

The light emitting end parts of the optical fibers 40a are not necessarily provided so as to be away from one another. Alternatively, a bundle of the optical fibers 40a can be positioned by the ferrule 9.

The present embodiment is configured such that laser beams emitted from the semiconductor laser 2 are employed as illumination light. Therefore, the laser beam irradiated surface of the light emitting section 5 does not need to be irradiated with all light emitted from a plurality of optical fibers 40a. Alternatively, for example, the transmission filter 7 can be directly irradiated with laser beams emitted from some of the optical fibers 40a.

(Light Emitting Section 5)

The light emitting section 5 emits light while being irradiated with the laser beams emitted from a light emitting end part of the optical fiber 40, as with the above-described light emitting section 5. The light emitting section 5 is provided in the vicinity of a first focal point of the reflector 6 (later described). The light emitting section 5 can be fixed to an end of a tubular part that penetrates a center part of the reflector 6. In this case, the optical fiber 40 can pass through the tubular part.

(Reflector 6)

The reflector 6 is a member on which surface a metal thin film is formed. The reflector 6 reflects and focalizes light emitted from the light emitting section 5. Since the headlamp 20 is the projector headlamp, the reflector 6 basically has an elliptical cross section parallel to an axis direction of reflected light. The reflector 6 has the first focal point and a second focal point that is closer to an opening of the reflector 6 than the first focal point is. The convex lens 13 later described is provided so as to have a focal point in the vicinity of the second focal point, and projects forward, the light converged on the second focal point by the reflector 6.

(Transmission Filter 7)

The transmission filter 7 shields coherent components included in laser beams, whereas transmits incoherent components included in the laser beams, as early described. The transmission filter 7 can emit outside not only light emitted from the light emitting section 5 but also the incoherent components included in the laser beams. This allows the headlamp 20 to emit white light having a high color temperature.

(Convex Lens 13)

The convex lens 13 converges the light emitted from the light emitting section 5, and then projects converged light ahead of the headlamp 20. The convex lens 13 has its focal point in the vicinity of the second focal point of the reflector 6. The convex lens 13 has a light axis that penetrates a substantially center part of a light emitting surface of the light emitting section 5. The convex lens 13 is held by the lens holder 8. This determines a relative position of the convex lens 13 to the reflector 6. The lens holder 8 can be provided to be part of the reflector 6.

(Other Members)

The housing 10 constitutes a main body of the headlamp 20, and houses the reflector 6 and other members. The optical fiber 40 penetrates the housing 10. The semiconductor laser 2 is provided outside the housing 10. The semiconductor laser 2 generates heat while the semiconductor laser 2 is emitting laser beams. Since the semiconductor laser 2 is provided outside the housing 10, the semiconductor laser 2 can be efficiently cooled down. Further, it is preferable that the semiconductor laser 2 be provided so that the semiconductor laser 2 is easily exchangeable because the semiconductor laser 2 is likely to break down. If these regards are not considered, the semiconductor laser 2 can be provided in the housing 10.

The extension 11 is provided on sides in front of the reflector 6. The extension 11 not only hides an inner structure of the headlamp 20 so as to improve an appearance of the headlamp 20 but also causes people to more strongly feel as if the reflector 6 were integral with a vehicle body. The extension 11 is a member on which surface a metal thin film is formed, as with the surface of the reflector 6.

The lens 12 is provided in an opening of the housing 10, and seals the headlamp 20. The light emitted by the light emitting section 5 is emitted ahead of the headlamp 20 via the lens 12.

As described above, the headlamp of the present invention is not limited to a specific structure. What is important in the present invention is that the headlamp emits outside, as white light, not only the light emitted from the light emitting section 5 but also part of the laser beams emitted from the semiconductor laser 2, so that it is possible to increases a color temperature of the white light.

### Embodiment 2

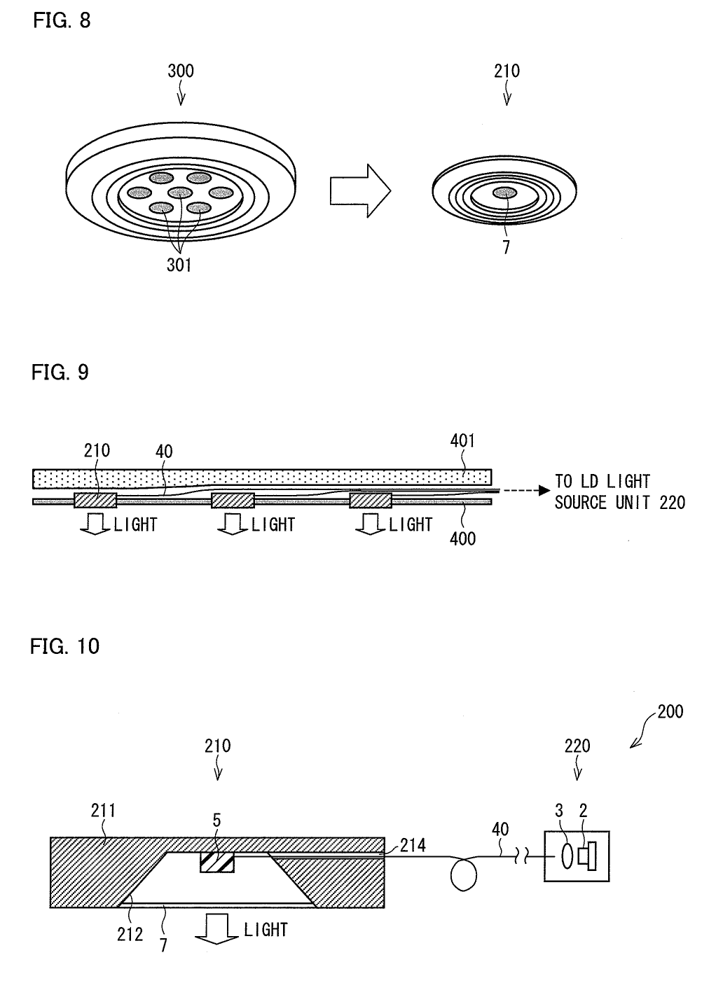

The following describes another embodiment of the present invention with reference to FIGS. 8 through 13. Note that like reference numerals herein refer to corresponding members of Embodiment 1, and descriptions of such members are omitted here.

In this embodiment, a laser down light 200 is described as an example of the illumination apparatus of the present invention. The laser down light 200 is an illumination apparatus that is provided on a ceiling of a structure such as a house or a vehicle. The laser down light 200 employs, as illumination light, fluorescence generated by irradiation of the light emitting section 5 with the laser beams emitted from the semiconductor laser 2.

Note that another illumination apparatus having a configuration identical to that of the laser down light 200 can be provided on a sidewall or floor of a structure. A place where the illumination apparatus is provided is not limited to a specific place.

FIG. 8 is a schematic diagram showing external appearances of a light emitting unit 210 and a conventional LED down light 300. FIG. 9 is a cross-sectional view of a ceiling on which the laser down light 200 is provided. FIG. 10 is a cross-sectional view showing the laser down light 200. As shown in FIGS. 8 through 10, the laser down light 200 is embedded in a top board 400, and includes (i) light emitting units 210 that emits illumination light and (ii) an LD light source unit 220 that supplies laser beams to the light emitting units 210 via the respective optical fibers 40. The LD light source unit 220 is not provided on the ceiling but provided in a place (for example, a sidewall of a house) which a user can easily reach. The reason why where the LD light source unit 220 is provided can be freely determined is that the LD light source unit 220 and the light emitting units 210 are connected to each other via the respective optical fibers 40. The optical fibers 40 are provided in a space between the top board 400 and a heat insulating material 401.

(Configuration of Light Emitting Unit 210)

The light emitting unit 210 includes a housing 211, the optical fiber 40, the light emitting section 5 and the transmission filter 7, as shown in FIG. 10.

The housing 211 has formed a concave part 212. The light emitting section 5 is provided on a bottom surface of the concave part 212. The concave part 212 has a surface on which a metal thin film is formed. The concave part 212 functions as a reflector.

The housing 211 also has a path 214 that allows the optical fiber 40 to extend up to the light emitting section 5 via the path 214. A positional relationship of the light emitting end part of the optical fiber 40 with the light emitting section 5 is identical to that described above (see FIG. 7).

The transmission filter 7 is a transmittable resin plate for transmitting light having a specific wavelength domain, and is provided so as to close up an opening of the concave part 212. It is preferable that the transmission filter 7 be made from a material for (i) shielding the coherent components included in the laser beams and (ii) transmitting the incoherent components and white light into which the light emitting section 5 converts the laser beams.

In FIG. 8, the light emitting unit 210 has a circular shape. However, a shape of the light emitting unit 210 (more specifically, a shape of the housing 211) is not limited to a specific one.

Note that a down light is different from a headlamp in that the down light does not need to have an ideal point source but needs to have only one light emitting point. Therefore, a shape, a size and a location of the light emitting section 5 of the down light are less restricted than those of the headlamp.

(Configuration of LD Light Source Unit 220)

The LD light source unit 220 includes the semiconductor laser 2, the aspheric lens 3 and the optical fiber 40.

The incident end part that is an end part of the optical fiber 40 is connected to the LD light source unit 220. The laser beams emitted from the semiconductor laser 2 enter the incident end part of the optical fiber 40 via the aspheric lens 3.

The LD light source unit 220 shown in FIG. 10 includes merely a pair of the semiconductor laser 2 and the aspheric lens 3. Note, however, that, in a case where a plurality of light emitting units 210 are provided, a bundle of the optical fibers 40 that extend from the respective plurality of light emitting units 210 can be connected to a single LD light source unit 220. In this case, the single LD light source unit 220 contains plural pairs of the semiconductor laser 2 and aspheric lens 3, and therefore functions as a central power source box.

(Modified Example of a Method for Providing the Laser Down Light 200)

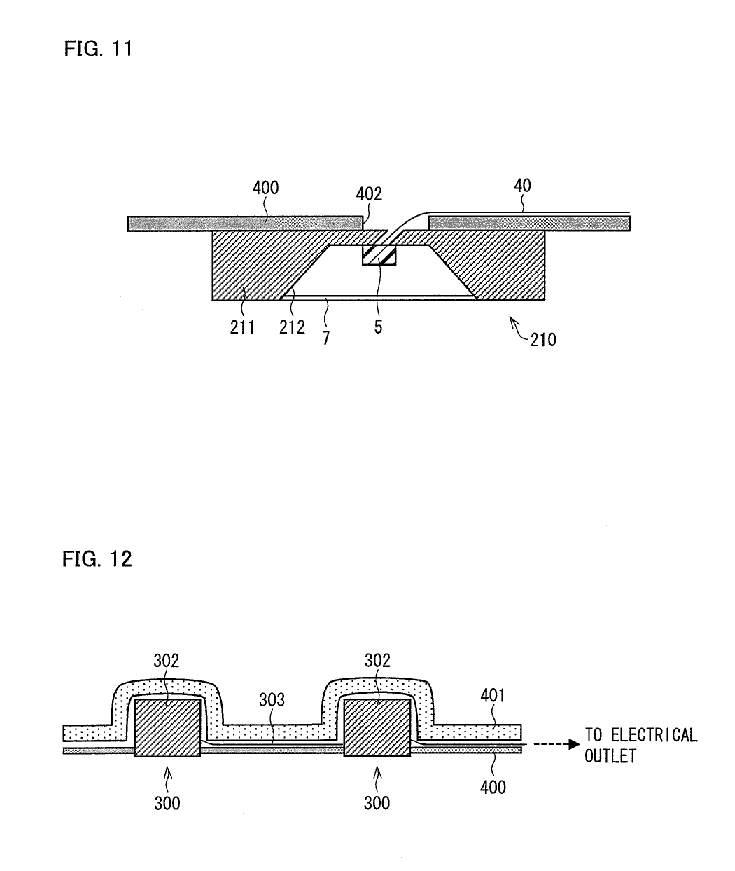

FIG. 11 is a cross-sectional view showing a modified example of a method for providing the laser down light 200. According to the modified example (see FIG. 11), a main body of the laser down light 200 (light emitting unit 210) can be attached, by use of, for example, a strong adhesive tape, to the top board 400 having a small through-hole 402 for causing only the optical fiber 40 to pass therethrough. The reason why the main body can be attached to the top board 400 is that the main body has features of thinness in thickness and lightness in weight. This makes it possible to alleviate a restriction on provision of the laser down light 200, and to remarkably reduce a cost for providing the laser down light 200.

(Comparison of the Laser Down Light 200 with the Conventional LED Down Light 300)

As shown in FIG. 8, the conventional LED down light 300 includes a plurality of light transmitting plates 301 from each of which illumination light is emitted. That is, the LED down light 300 has a plurality of light emitting points. The reason why the LED down light 300 should have the plurality of light emitting points is that, since light flux individually emitted from the plurality of light emitting points is relatively small, sufficient light flux cannot be obtained unless the LED down light 300 has the plurality of light emitting points.

In contrast, the laser down light 200 is an illumination apparatus having large light flux, and therefore a single light emitting point is sufficient. This brings about an effect of obtaining clear shade derived from illumination light. A color rendering property of illumination light can be enhanced in a case where a high color rendering fluorescent material (e.g. any combination of plural kinds of oxynitride fluorescent material and/or nitride fluorescent material) is used as the fluorescent material of the light emitting section 5.

FIG. 12 is a cross-sectional view of a ceiling on which an LED down light 300 is provided. According to the LED down light 300 shown in FIG. 12, a housing 302, which houses an LED chip, a power source and a cooling unit, is embedded in a top board 400. The housing 302 is relatively large in size. The heat insulating material 401 has a concave part in which the housing 302 fits. The housing 302 is provided in the concave part of the heat insulating material 401. The housing 302 is connected to a power source line 303. The power source line 303 is connected to an electrical outlet (not shown).

Such a configuration of the LED down light 300 will cause the following problem: A temperature of a ceiling is increased by usage of the LED down light 300, and therefore a cooling efficiency of a room is decreased. This is because the light source (LED chip) and the power source, that serve as respective heat generating sources, are provided between the top board 400 and the heat insulating material 401.

The LED down light 300 causes another problem of an increase in a total cost. This is because each light source requires a corresponding power source and a corresponding cooling unit.

The LED down light 300 causes a further problem that it is often the case that it is difficult to provide the LED down light 300 in a space between the top board 400 and the heat insulating material 401. This is because the housing 302 is relatively large in size.

In contrast, since the light emitting unit 210 of the laser down light 200 includes no large heat generating source, a cooling efficiency of a room will never be decreased. It is therefore possible to prevent an increase in cost for cooling the room.

It is also possible to reduce the laser down light 200 in its size and thickness because each light emitting unit 210 does not require a corresponding power source and a corresponding cooling unit. This brings about an effect of alleviating a restriction on a space where the laser down light 200 is provided, and therefore it becomes easy to provide the laser down light 200 in an existing house.

Since the laser down light 200 is thin and light in weight, as early described, it is possible to (i) provide the light emitting unit 210 on a surface of the top board 400, (ii) make smaller the restriction on the provision of the laser down light 200 as compared with the provision of the LED down light 300 because the space between the heat insulating material 401 and the top board 400 is hardly required, and (iii) remarkably reduce the cost for providing the laser down light 200.

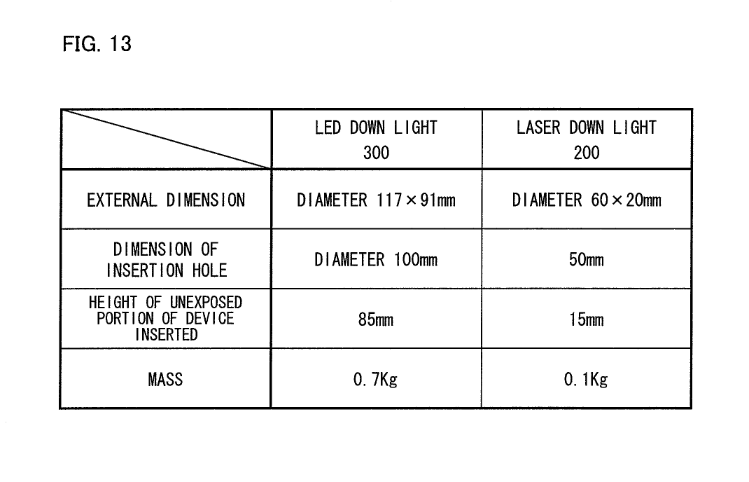

FIG. 13 shows a comparison of specifications between the laser down light 200 and the LED down light 300. According to the comparison shown in FIG. 13, the laser down light 200 has a volume of 94% of and a mass of 86% of the LED down light 300.

It is further possible to provide the LD light source unit 220 in a place (height) that a user easily reaches. This makes it easy to exchange the semiconductor laser 2 even in a case where the semiconductor laser 2 breaks down. Further, it is possible to collectively control a plurality of semiconductor lasers 2 by guiding, to a single LD light source unit 220, the optical fibers 40 extending from a plurality of light emitting units 210. Hence, the plurality of semiconductor lasers 2 can be easily exchanged.

In a case where a high color rendering fluorescent material is used as a fluorescent material of the LED down light 300, it is necessary for the LED down light 300 to consume a power of 10 W for causing the LED down light 300 to emit a light flux of approximately 500 μm. In contrast, it is necessary for the laser down light 200 to consume a power of 3.3 W (optical output) for causing the laser down light 200 to emit a light flux of approximately 500 lm. The optical output of 3.3 W corresponds to a power consumption of 10 W in a case where an LD efficiency is 35%. Since the LED down light 300 consumes a power of 10 W, there is no substantial difference in power consumption between the laser down light 200 and the LED down light 300. Hence, the laser down light 200 brings the above-described various advantages with a power consumption identical to that of the LED down light 300.

As described above, the laser down light 200 includes (i) the light source unit 220 including at least one semiconductor laser 2 for emitting laser beams, (ii) at least one light emitting unit 210 that includes the light emitting section 5 and the concave part 212 serving as a reflector, and (iii) the transmission filter 7. The transmission filter 7 shields the coherent components included in the laser beams, whereas transmits the incoherent components included in the laser beams and white light into which the laser beams are converted by the light emitting section 5. The light emitting section 5 includes, for example, the first fluorescent material having a peak of emission spectrum which peak falls in the vicinity of 510 nm, and the second fluorescent material having a peak of emission spectrum which peak falls in the vicinity of 640 nm. With the configuration, the laser down light 200 can emit white light that secures safety of human eyes and that has a high color temperature, as with the headlamps 1 and 20 of Embodiment 1.

[Another Description of the Present Invention]

The present invention can also be described as below.

It is preferable to configure an illumination apparatus in accordance with an embodiment of the present invention such that the transmission filter transmit ones of the incoherent components, which ones have respective wavelengths longer than those of the coherent components.

In the photopic vision, sensitivity of human eyes becomes highest to light having a wavelength of 555 nm. Meanwhile, in the scotopic vision, the sensitivity of human eyes becomes highest to light having a wavelength of 507 nm. Two wavelength ranges in which wavelengths of the incoherent components fall on a short wavelength side of and on a long wavelength side of a wavelength range in which wavelengths of coherent components (light having a peak of emission spectrum of exciting light) fall.

According to the configuration, the excitation light source emits exciting light having a wavelength which falls in the vicinity of the bluish purple wavelength range, and the transmission filter transmits, among incoherent components included in the exciting light, incoherent components on a long wavelength side (light having a wavelength longer than those of the coherent components included in the exciting light). It is accordingly possible to emit light whose spectral luminous efficiency is similar to the above one (555 nm or 507 nm) among the incoherent components whose wavelengths fall in the wavelength range on the long wavelength side or the short wavelength side. This allows an improvement of the spectral luminous efficiency in both photopic vision and scotopic vision.

It is preferable to configure the illumination apparatus in accordance with an embodiment of the present invention such that the excitation light source be a semiconductor laser having a gain guide structure.

The semiconductor laser having a gain guide structure has a broader emission area where exciting light is emitted, as compared with, for example, a semiconductor laser having a real guide structure. Therefore, in a case where the semiconductor laser having a gain guide structure is used as an excitation light source, the semiconductor laser having a gain guide structure can increase the incoherent components without improving its emission intensity.

It is preferable to configure the illumination apparatus in accordance with an embodiment of the present invention such that the excitation light source emit exciting light having a peak of oscillation wavelength which peak falls within a range from 400 nm to 420 nm.

According to the configuration, the excitation light source emits the exciting light having the peak of oscillation wavelength which peak falls within the range from 400 nm to 420 nm. That is, the excitation light source can emit exciting light having a bluish purple oscillation wavelength. This allows the illumination apparatus to emit light having a wavelength which falls in the vicinity of the bluish purple wavelength range, that is, light containing blue components by transmission of the exciting light through the transmission filter.

The coherent components contained in the exciting light emitted from the excitation light source are included mainly in a peak wavelength range of oscillation wavelengths of the exciting light, and the peak wavelength range is very narrow. In contrast, the incoherent components are included in peripheral wavelength ranges of the peak wavelength range. The peripheral wavelength ranges are broader than the peak wavelength range. The illumination apparatus of the present invention includes the transmission filter for (i) shielding the coherent components included in such a greatly narrow peak wavelength range and (ii) transmitting the incoherent components included in the peripheral wavelength ranges of the peak wavelength range. This allows the illumination apparatus of the present invention to increase the color temperature of illumination light by employing, as part of the illumination light, the incoherent components.

Patent Literature 1 discloses a light emitting diode for emitting green or bluish green light by decreasing white light. However, Patent Literature 1 is silent about a concrete wavelength range of the green or bluish green light.

It is preferable to configure the illumination apparatus in accordance with an embodiment of the present invention such that the light emitting section include (i) a first fluorescent material having a peak of emission spectrum which peak falls in the vicinity of 510 nm and (ii) a second fluorescent material having a peak of emission spectrum which peak falls in the vicinity of 640 nm.

The configuration makes it possible to provide an illumination apparatus including a light emitting section for emitting white light, by using the exciting light having the bluish purple oscillation wavelength in combination with the first and second fluorescent materials (a fluorescent material having a peak wavelength in the vicinity of 510 nm and a fluorescent material having a peak wavelength in the vicinity of 640 nm).

As described above, in the scotopic vision, the sensitivity of human eyes becomes highest to light having a wavelength of 507 nm. According to the configuration, the fluorescent material having the peak of emission spectrum which peak falls in the vicinity of 510 nm is used. This allows the illumination apparatus of the present invention to improve a spectral luminous efficiency even in a surrounding dark environment.

A vehicular headlamp in accordance with an embodiment of the present invention, including: the illumination apparatus; and a reflector for reflecting the light emitted from the light emitting section so as to form a light flux that travels within a predetermined solid angle.

According to the configuration, the reflector reflects the light emitted from the light emitting section so as to form a light flux that travels ahead of the vehicular headlamp. Since the vehicular headlamp includes the illumination apparatus, the vehicular headlamp can emit not only the light reflected by the reflector but also light that (i) leaks out from the light emitting section (or that is not emitted to the light emitting section), (ii) has a wavelength which falls in the bluish purple wavelength range and (iii) has a high color temperature. Hence, as with the illumination apparatus, the vehicular headlamp can emit light having an increased color temperature.

The illumination apparatus in accordance with an embodiment of the present invention relates to a laser illumination light source including (i) a fluorescent material light emitting section and (ii) a semiconductor laser serving as an excitation light source having an oscillation wavelength which falls in a bluish purple wavelength range in the vicinity of 405 nm. The illumination apparatus includes a Caα-SiAlON: Ce³⁺ as a fluorescent material constituting at least a part of the fluorescent material light emitting section, and a filter for shielding the oscillation wavelength (peak wavelength) of the semiconductor laser light source and transmitting light having a wavelength longer than the oscillation wavelength (not coherent light but so-called EL emission components (EL stands for electroluminescence)). This allows the illumination apparatus to increase a color temperature of illumination light by using, in combination with the illumination light, blue components of light emitted from the excitation light source, which are brought by EL emission safe to eyes.

The present invention is not limited to the description of the embodiments above, and can therefore be modified by a skilled person in the art within the scope of the claims. Namely, an embodiment derived from a proper combination of technical means disclosed in different embodiments is encompassed in the technical scope of the present invention.

### INDUSTRIAL APPLICABILITY

The present invention is applicable to an illumination apparatus or a headlamp, particularly to, for example, a vehicular headlamp, which should emit illumination light having a high color temperature.

### REFERENCE SIGNS LIST

1: headlamp (illumination apparatus or vehicular headlamp)
2: semiconductor laser (excitation light source)
5: light emitting section
6: reflector
7: transmission filter
20: headlamp (illumination apparatus or vehicular headlamp)

1. An illumination apparatus, comprising:
an excitation light source for emitting exciting light having a bluish purple oscillation wavelength;
a light emitting section for emitting light while being irradiated with the exciting light emitted from the excitation light source; and
a transmission filter for shielding coherent components included in the exciting light whereas transmitting incoherent components included in the exciting light.

2. The illumination apparatus as set forth in claim 1, wherein:
the transmission filter transmits ones of the incoherent components, which ones have respective wavelengths longer than those of the coherent components.

3. The illumination apparatus as set forth in claim 1, wherein:
the excitation light source is a semiconductor laser having a gain guide structure.

4. The illumination apparatus as set forth in claim 1, wherein:
the excitation light source emits exciting light having a peak of oscillation wavelength which peak falls within a range from 400 nm to 420 nm.

5. The illumination apparatus as set forth in claim 1, wherein:
the light emitting section includes (i) a first fluorescent material having a peak of emission spectrum which peak falls in the vicinity of 510 nm and (ii) a second fluorescent material having a peak of emission spectrum which peak falls in the vicinity of 640 nm.

6. A vehicular headlamp, comprising:
an illumination apparatus as set forth in claim 1; and
a reflector for reflecting the light emitted from the light emitting section so as to form a light flux that travels within a predetermined solid angle.
